(19) United States
(12) Patent Application Publication
(10) Pub. No.: US 2010/0178999 A1
(43) Pub. Date: Jul. 15, 2010

(54) Golf Club Heads With Augmented Side Surfaces And Weighting, And Related Methods

(75) Inventors: Michael Nicolette, Scottsdale, AZ (US); Brad D. Schweigert, Anthem, AZ (US)

Correspondence Address: KARSTEN MANUFACTURING CORPORATION;LEGAL DEPARTMENT, 2201 WEST DESERT COVE, PHOENIX, AZ, 85029, US

(73) Assignee: Karsten Manufacturing Corporation, Phoenix, AZ (US)

(21) Appl. No.: 12/728,824

(22) Filed: Mar. 22, 2010

Related U.S. Application Data
(62) Division of application No. 11/828,033, filed on Jul. 25, 2007.

(51) Int. Cl. A63B 53/04; B23P 15/00

(52) U.S. Cl. 473/349; 29/592

(57) ABSTRACT

Embodiments of golf club heads with augmented side surfaces and weighting are described herein. Other embodiments and related methods are also disclosed herein.

### CROSS-REFERENCE TO RELATED APPLICATION

This application is a divisional patent application claiming priority to U.S. patent application Ser. No. 11/828,033, filed Jul. 25, 2009, and titled Golf Clubs and Methods of Manufacture. The disclosure of the above-referenced application is incorporated herein by reference.

### TECHNICAL FIELD

This disclosure relates generally to golf club heads, and relates more particularly to golf club heads and methods of manufacturing a golf club head.

### BACKGROUND

Golf clubs and specifically golf club heads of various designs have typically been developed to improve the functionality of a golfer's swing and resulting golf shot. In particular, many golfers are unable or lack consistency to hit “down” on a ball, that is, to regularly hit the ball squarely. Golf club design and particularly, golf club head design may be used to optimize a golf club head's weighting scheme, for example, center of gravity position and moments of inertia. Such designs can mitigate a golfer's inconsistency problems. Perimeter weighting and additional lower toe weighting may strategically position the center of gravity and may induce the golfer during his swing, to hit “down” on the ball, thus, hitting the ball squarely.

### BRIEF DESCRIPTION OF THE DRAWINGS

FIG. 1 illustrates a back view of an exemplary golf club head according to an embodiment of the golf clubs and methods of manufacture described herein;

FIG. 2 illustrates a top down view of the exemplary golf club head showing the top rail;

FIG. 3 illustrates a bottom up view of the exemplary golf club head showing the sole;

FIG. 4 illustrates a front face view of an exemplary golf club, according to a second embodiment;

FIG. 5 illustrates a side view of the exemplary golf club head of FIG. 1 showing the toe region;

FIG. 6 illustrates a side view of the exemplary golf club head showing the heel region;

FIG. 7 illustrates an exploded back face view of an exemplary golf club head showing a non-integral toe weight, according to a third embodiment;

FIG. 8 depicts a flow diagram representation of one manner in which a golf club head may be manufactured, according to a fourth embodiment;

FIG. 9 depicts a flow diagram representation of another manner in which a golf club may be manufactured, according to a fifth embodiment;

FIG. 10 depicts a flow diagram representation of yet another manner in which a golf club head may be manufactured, according to a sixth embodiment;

FIG. 11 illustrates a cross-section view of the exemplary golf club head of FIG. 1 showing from the top down various elements described herein;

FIG. 12 illustrates a cross-section view of the exemplary golf club head showing from the side towards the heel region various elements described herein;

FIG. 13 illustrates an enlarged view of the exemplary golf club head showing the angle between a first direction and a second direction; and

FIG. 14 illustrates an enlarged view of the exemplary golf club head showing the radius of curvature between the first direction and the second direction.

For simplicity and clarity of illustration, the drawing figures illustrate the general manner of construction, and descriptions and details of well-known features and techniques may be omitted to avoid unnecessarily obscuring the golf clubs and their methods of manufacture. Additionally, elements in the drawing figures are not necessarily drawn to scale. For example, the dimensions of some of the elements in the figures may be exaggerated relative to other elements to help improve understanding of embodiments of the golf clubs and their methods of manufacture. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of golf clubs and methods of manufacture described herein are, for example, capable of operation in sequences other than those illustrated or otherwise described herein. Furthermore, the terms “contain,” “include,” and “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “side,” “under,” “over,” and the like in the description and in the claims, if any, are used for descriptive purposes and not necessarily for describing permanent relative positions. It is to be understood that the terms so used are interchangeable under appropriate circumstances such that the embodiments of golf clubs and methods of manufacture described herein are, for example, capable of operation in other orientations than those illustrated or otherwise described herein. The term “coupled,” as used herein, is defined as directly or indirectly connected in an electrical, physically, mechanical, or other manner.

### DESCRIPTION OF EXAMPLES OF EMBODIMENTS

In one embodiment of the golf clubs and methods of manufacture described herein, a golf club head comprises, a toe region having a top portion and a bottom portion, a heel region opposite the toe region, and also having a top portion and a bottom portion. In this embodiment, the golf club head may comprise a hosel adjacent to the top portion of the heel region. In a different embodiment, however, the golf club head may comprise a bore, instead of a hosel. Regardless of whether the golf club head comprises a hosel or a bore, the golf club head has a back face, a front face opposite the back face, a first weight at a perimeter of the back face, and a second weight at the back face. The second weight is located at the bottom portion of the toe region, and farther away from the back face than the first weight.

In another embodiment of golf clubs and methods of manufacture, a golf club head comprises, a heel region, a toe region opposite the heel region, a front face, and a back face opposite the front face. The golf club head also comprises a top rail extending from the front face towards and beyond the back face to create a top rail width, and the top rail extends from the heel region to the toe region. The golf club head also has a sole substantially opposite the top rail, and a side surface extending from the top rail to the sole at the toe region. In this embodiment, the side surface further comprises a side surface width extending from the front face towards and beyond the back face, and the side surface width increases non-linearly from the top rail to the sole. The side surface width has a maximum distance towards the sole.

In an embodiment of golf clubs and methods of manufacture, a method for manufacturing a golf club head comprises providing a body to have a hosel, a heel region, a toe region, a front face, and a back face. This embodiment also comprises providing the body to include a top rail to extend from the front face towards and beyond the back face, and to extend from the heel region to the toe region. The body is also provided to include a sole, and a side surface that extends from the top rail to the sole at the toe region. The side surface further comprises a side surface width extending from the front face towards and beyond the back face, and the side surface width increases non-linearly from the top rail to the sole. The side surface width also has a maximum distance towards the sole.

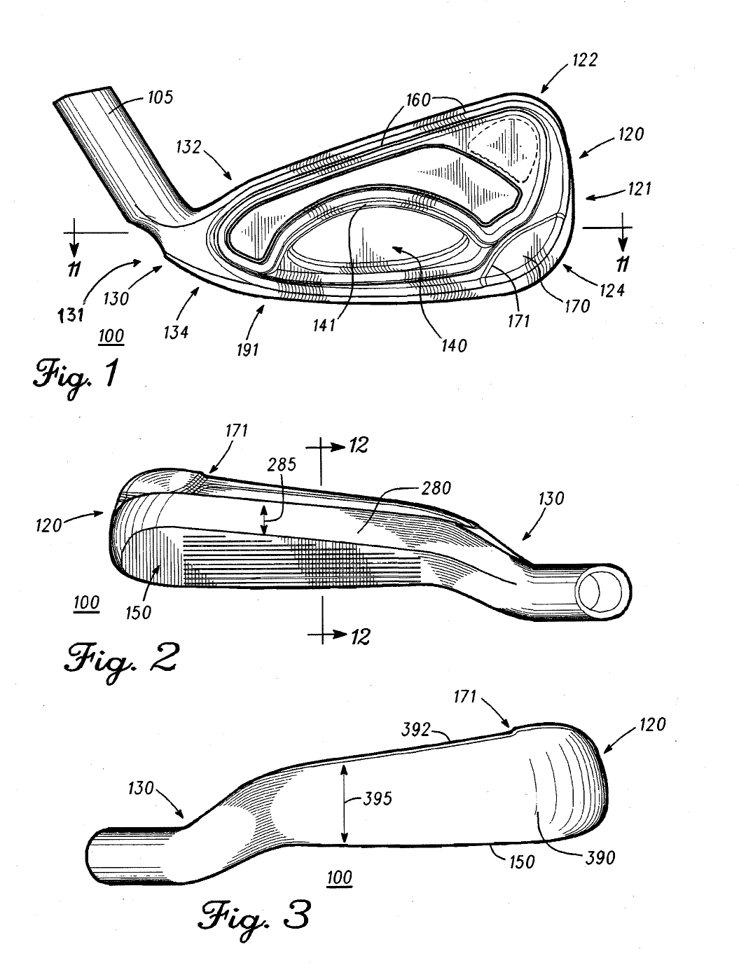

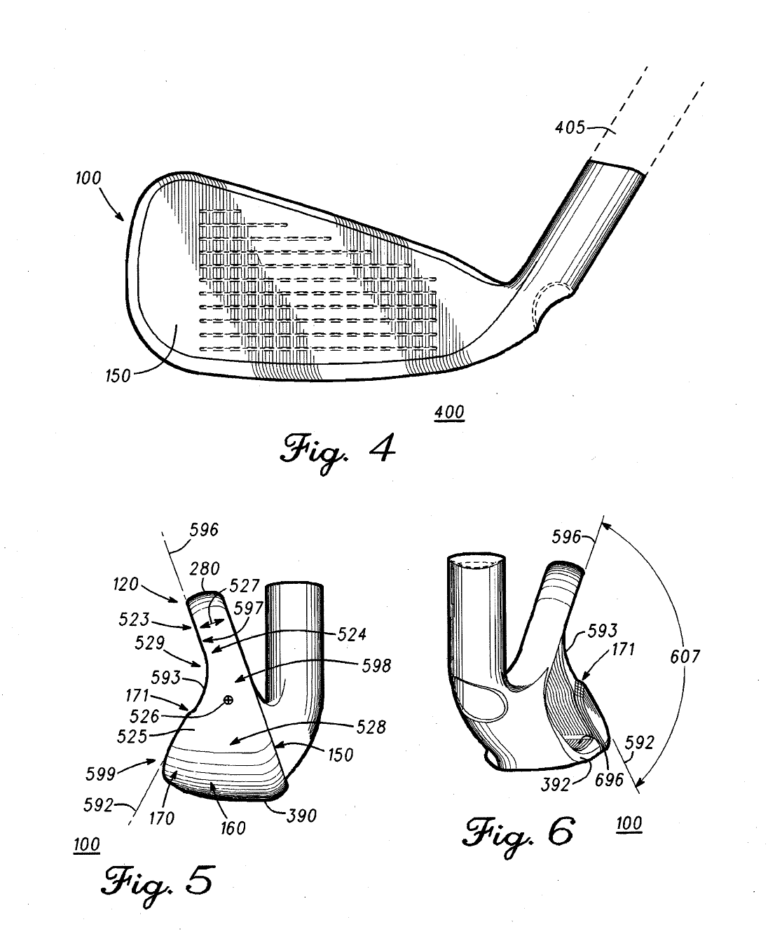

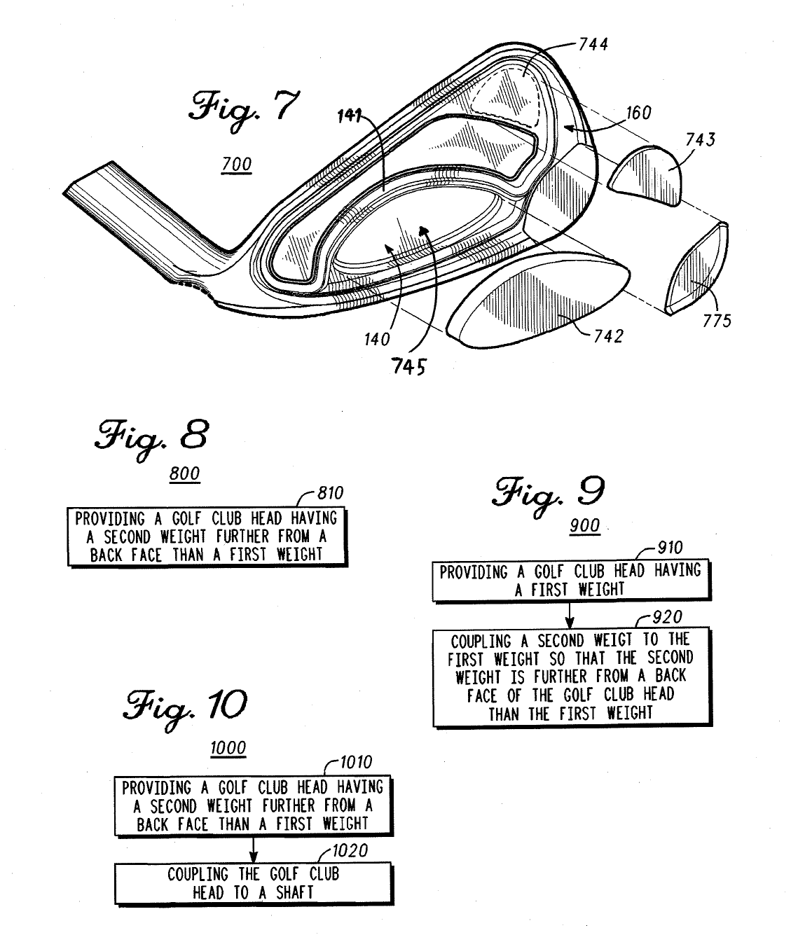

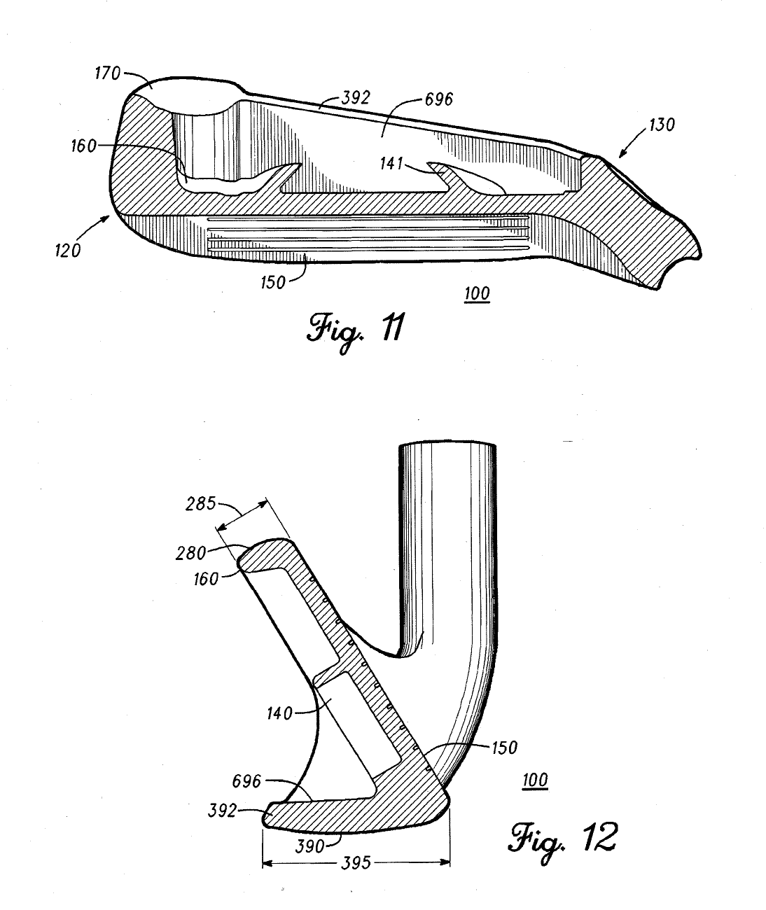

Turning now to the figures, FIG. 1 illustrates a back view of an exemplary golf club head 100 according to an embodiment of golf clubs and methods of manufacture described herein. Golf club head 100 comprises a toe region 120 having a top portion 122 and a bottom portion 124, a heel region 130 opposite the toe region 120 and also having a top portion 132 and a bottom portion 134. The golf club head 100 further comprises a hosel 105 adjacent to the top portion 132 of the heel region 130, and the golf club head 100 has a back face 140, a front face 150 (FIG. 2) opposite the back face 140, a first weight 160 at a perimeter of the back face 140, and a second weight 170 at the back face 140. The second weight 170 is located at or proximate to the bottom portion 124 of the toe region 120, and farther away from the back face 140 than the first weight 160. The second weight 170 may provide additional weighting at the perimeter of the club head that induces a golfer to swing the club in a more optimal manner. The second weight 170 may be at an intersection of the sole 190 (FIG. 3) and the toe region 120. By placing the additional weighting at the lower toe region, the additional weight induces the golfer to swing “down” and “outward” thereby resulting in a beneficial swing plane.

Among the various embodiments of golf clubs and methods of manufacture described herein, for example, the second weight 170 may be located primarily and only at the bottom portion 124 of the toe region 120. In one embodiment of golf clubs and methods of manufacture, the first weight 160 is at the toe region 120. The first weight 160 may also be located at the heel region 130. The first weight 160 may also be located at a top portion 132, a bottom portion 191, and side portions 121 and 131 of the back face 140. In one embodiment of golf clubs and methods of manufacture, the first weight 160 is not required to be at the entire perimeter of the back face 140. (e.g., continuously extending along the entire perimeter of back face 140). For example, the first weight 160 may be segmented into two or more portions extending along the perimeter of the back face 140.

Continuing with the embodiment of FIG. 1, FIG. 11 illustrates a cross-sectional view corresponding to line 11-11 in FIG. 1. In one embodiment, golf club head 100 comprises the second weight 170 located farther away from the back face 140 (FIG. 1) than first weight 160. For example, the second weight 170 may extend from about 1.0 cm to about 2.0 cm beyond first weight 160. In various embodiments of golf clubs and methods of manufacture, the various embodiments may comprise the second weight 170 to be located at a portion of the perimeter of the back face 140, and/or only at a portion of the perimeter of the back face 140. In yet another embodiment of the golf clubs and methods of manufacture, the second weight 170 is located over the first weight 160. In still yet another embodiment, the golf club head 100 comprises the first weight 160 to separate the back face 140 from the second weight 170.

In another embodiment of golf clubs and methods of manufacture, the first weight 160 can be a first material and the second weight 170 can be a second material different from the first material. For example, the first material may comprise iron, and the second material may comprise a titanium alloy. The first and second materials may comprise other materials, as well. The first material may have a higher, lower, or the same density as the second material.

In other embodiments, however, the first weight 160 comprising a first material, and the second weight 170 likewise comprising the first material. For example, the first material may comprise an elemental metal such as iron, tungsten, and the like, or the first material may comprise of a metallic alloy.

In another embodiment of golf clubs and methods of manufacture and with reference to FIG. 5, a golf club head 500 comprises a second weight 170 to be integral with a first weight 160, that is, for example, the second weight 170 may be manufactured, such as cast, at the same time and/or in the same mold as the first weight 160. For example, with reference to FIG. 11, a cross-section view illustrates the second weight 170 integral with the first weight 160. However, in alternate embodiments, and with reference to FIG. 7, a golf club head 700 comprises a second weight 775 that is not integral with the first weight 160. In this embodiment, the second material weight 775 may be coupled to the first weight 160 using a suitable method to couple metals, for example, welding, swaging, and the like.

Returning to FIG. 1, in an embodiment of golf clubs and methods of manufacture, the golf club comprises the second weight 170 to be non-conformal with the first weight 160. For example, the contours 171 of the second weight 170 are delineated and visible. In this embodiment, the second weight 170 is visibly distinct from the first weight 160. Furthermore, in some embodiments of golf clubs and methods of manufacture, the second weight 170 is visibly distinct from the back view (FIG. 1), the bottom view (FIG. 3), the top view (FIG. 2), the side view from the heel (FIG. 6), the side view from the toe (FIG. 5), and/or a cross-section view (FIG. 11). In yet another embodiment of golf clubs and methods of manufacture, a transition from the second weight 170 to the first weight 160 comprises a substantially uniform and/or smooth or continuous transition, i.e., from one height to the next height.

In another embodiment of golf clubs and methods of manufacture and with reference to FIG. 2, the golf club head 100 comprises a top rail 280 extending from the front face 150 towards and beyond the back face 140 (FIG. 1) to create a top rail width 285. The top rail 180 extends from the heel region 130 to the toe region 120. The golf club head 100 also has a sole 390 (FIG. 3) substantially opposite the top rail 280, and a side surface 525 (FIG. 5) extending from the top rail 280 to the sole 390 at the toe region 120. In this embodiment, the side surface 525 further comprises a side surface width 527 extending from the front face 150 towards and beyond the back face 140 (FIG. 1), and the side surface width 527 increases non-linearly from the top rail 280 to the sole 390. The side surface width 527 has a maximum distance towards the sole 390.

In yet another embodiment of golf clubs and methods of manufacture and with reference to FIG. 3, the golf club head 100 comprises the sole 390 to have a sole width 395 extending from the front face 150 towards and beyond the back face 140 (FIG. 1), wherein the sole width 395 increases from the heel region 130 to the toe region 120, and a portion of the sole width 395 may be at least twice as wide as a portion of the top rail width 185 (FIG. 2). The sole width 395 may extend from the front face 150 to a rear sole edge 392 to create a portion of a rear sole wall 696 (FIG. 6), and the rear sole wall 696 may extend from the back face 140 (FIG. 1) to the back face rear sole edge 392 (FIG. 6).

Furthermore, the top rail width 285 (FIG. 2) may be substantially constant, and the minimum of the sole width 395 (FIG. 3) may be greater than the top rail width 285 (FIG. 2). In some embodiments, the sole width 395 (FIG. 3) may be at least twice the top rail width 185 (FIG. 2).

In yet another embodiment of golf clubs and methods of manufacture and with reference to FIG. 2, the golf club head 100 comprises the top rail width 185 to be substantially constant from the heel region 130 to the toe region 120. For example, the width at the heel region 130 is substantially the same width at the toe region 120, and every width between the heel region 130 and the toe region 120 is likewise the same width.

In another embodiment of golf clubs and methods of manufacture and with reference to FIG. 5, the golf club head 500 comprises the side surface width 527 to be substantially constant along a first portion 524 of the side surface 525. The first portion 524 of the side surface 525 may extend from the top rail 280 to a point adjacent to a midpoint 526 between the top rail 280 and the sole 390. Moreover, in some embodiments, the golf club head 100 comprises the first portion 524 of the side surface 525 to have a width substantially similar to the top rail width 285 (FIG. 2). The first portion 524 of the side surface 525 may be closer to the top rail 280 than the sole 390.

In an embodiment of golf clubs and methods of manufacture, the golf club head 100 comprises the side surface width 527 to increase along a second portion 528 of the side surface 525. The second portion 528 of the side surface 525 may extend from the point adjacent to the midpoint 526 to the sole 390. The second portion 528 of the side surface 525 may be closer to the sole 390 than the top rail 280.

In one embodiment, the side surface width 527 does not decrease when moving from the top rail 280 to the sole 390. In another embodiment, the side surface width 527 decreases at a portion of the side surface 525 when moving from the top rail 280 to the sole 390. In either of these two embodiments, the side surface width 527 has a maximum distance towards the sole 390, and such maximum distance may be at least three times the side surface width 527 as measured at the top rail 280. Moreover, and with reference to the cross-section view of FIG. 12, the top rail width 285 is less than the sole width 395. Also, FIG. 12 is the cross-sectional view corresponding to line 12-12 in FIG. 2

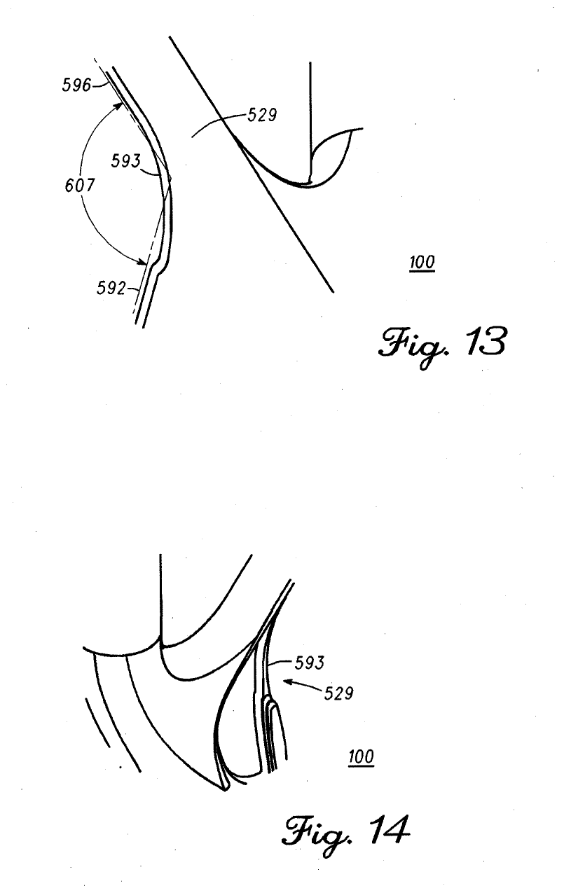

In another embodiment of golf clubs and methods of manufacture with reference to FIG. 5, the golf club head 100 comprises the side surface 525 to extend from the front face 150 towards and beyond the back face 140 (FIG. 1) to a side face back edge 523. The side face back edge 523 comprises a first portion 597, a second portion 598, and a third portion 599. In this embodiment, the first portion 597 of the side face back edge 523 is substantially parallel to the front face 150 and extends in a first direction 596 from the top rail 280 towards the second portion 598 of the side face back edge 523. The second portion 598 of the side face back edge 523 comprises a center transition region 529 between the first portion 597 and the third portion 599 of the side face back edge 523. The second portion 598 of the side face back edge 523 is adjacent to the midpoint 526. The center transition region 529 may comprise a radius of curvature 593 between the first direction 596 and the second direction 592 (FIGS. 13 and 14). The third portion 599 of the side face back edge 523 is non-parallel to the front face 150, and it extends in a second direction 592 from the second portion 598 of the side front back edge 523 towards the sole 390.

In another embodiment of golf clubs and methods of manufacture and with reference to FIG. 6, the golf club head 100 comprises an obtuse angle 607 between the first direction 596 and the second direction 592 (FIG. 13). The obtuse angle 607 may be in the range from approximately 115 degrees to approximately 155 degrees.

Returning to FIG. 1, in an embodiment of golf clubs and methods of manufacture, the golf club head 100 comprises an integral, arcuate reinforcing member 141 extending along the exposed back face 140 from the heel region 130 to the toe region 120. In various embodiments of golf clubs and methods of manufacture described herein, the back face 140 (FIG. 1) of the golf club head 100 may be at least fifty percent of the surface area of a strike face (i.e., the front face 150, FIG. 2).

In an embodiment of golf clubs and methods of manufacture, arcuate reinforcing rib 141 may partially define a cavity 745 (FIG. 7) that can provide for a cavity weight 742 to be inserted, which further may allow for adjusting the weighting so as to tailor the golf club head 700 for a particular golfer. Moreover, another cavity 744 may provide for another weight 743 to additionally tailor the weighting of golf club head 700.

The aforementioned embodiments of golf clubs and methods of manufacture may further comprise, and with reference to FIG. 4, a golf club 400 comprising a shaft 405 coupled to a golf club head such as, for example, the golf club head 100. The other golf club heads disclosed herein may also be coupled to the shaft 405 to form a golf club such as golf club 400. Furthermore, among the various embodiments described herein, the golf clubs and their methods of manufacture may be for irons, drivers, fairway woods, hybrids, putters, and/or other suitable types of clubs.

In an embodiment of golf clubs and methods of manufacture, and with reference to FIG. 8, a method 800 for manufacturing a golf club head comprises providing a golf club head (a block 810). The golf club head of the block 810 may be similar to the golf club head 100 shown in FIGS. 1-6 and 11-14, and/or the golf club head 700 in FIG. 7. In this embodiment, the golf club head of the block 810 may have a second weight farther from a back face than a first weight, similar to the first weight 160 and the second weight 170 in FIG. 1. As an example, the first and second weights may be integral with the golf club head, as explained previously for the first weight 160 and the second weight 170 in FIG. 1.

In a different embodiment, a method 900 for manufacturing a golf club head comprising providing a golf club head having a first weight (a block 910). As an example, the golf club head and the first weight of the block 910 may be similar to the golf club head 700 and the first weight 160 of FIG. 7. The method 900 may continue with coupling a second weight to the first weight (a block 920). In this coupling step, the second weight may be located farther from the back face of the golf club head than the first weight. The second weight of the block 920 may be similar to second weight 775 of FIG. 7. The coupling step may include welding, swaging, and/or other suitable techniques.

In yet another embodiment of a manufacturing method, a method 1000 for manufacturing a golf club comprises providing a golf club (a block 1010). The golf club head of the block 1010 may be similar to the golf club head 100 shown in FIGS. 1-6 and 11-14, and/or the golf club head 700 in FIG. 7. In this embodiment, the golf club head of the block 1010 may have a second weight farther from a back face than a first weight, similar to the first weight 160 and the second weight 170 in FIG. 1. As an example, the first and second weights may be integral with the golf club head, as explained previously for the first weight 160 and the second weight 170 in FIG. 1.

The method 1000 may continue with coupling the golf club head to a shaft (a block 1020). The shaft of the block 1020 may be similar to the shaft 405 of FIG. 4. As an example, the coupling step of the block 1020 may include welding, adhering, taping, and other suitable techniques.

Although a particular order of actions is illustrated in FIGS. 8-10, these actions may be performed in other temporal sequences. For example, the actions depicted in FIGS. 8-10 may be performed sequentially, concurrently, or simultaneously.

The providing steps in the described methods of FIGS. 8-10 may include designing and/or manufacturing processes or activities. As an example, body 100 in FIG. 8 may be manufactured using a metal casting process. Furthermore, the described methods may be used to manufacture the other aspects of body 100 described with reference to FIGS. 1-7 and 11-14, as well as aspects of body 100 in FIGS. 9 and 10. Manufacturing may also include various assembly, finishing, heat treating, tempering, polishing, etching, engraving, and the like.

Additional examples of such changes have been given in the foregoing description. Accordingly, the disclosure of embodiments of golf clubs and methods of manufacture is intended to be illustrative of the scope of golf clubs and methods of manufacture and is not intended to be limiting. For example, in one embodiment, a golf club head may have one or more features of FIG. 1, with or without the features described with reference to FIGS. 2-7. Similarly, in different embodiments, a golf club head may have one or more of the features of FIG. 5, with or without the features of FIGS. 1-3 and 6-7, or a golf club head may have one or more of the features of FIG. 7 with or without the features of FIGS. 1-6. Other permutations of the different embodiments having one or more of the features of the various figures is likewise contemplated. It is intended that the scope of golf clubs and methods of manufacture shall be limited only to the extent required by the appended claims.

The golf clubs and methods of manufacture discussed herein may be implemented in a variety of embodiments, and the foregoing discussion of these embodiments does not necessarily represent a complete description of all possible embodiments. Rather, the detailed description of the drawings, and the drawings themselves, disclose at least one preferred embodiment of golf clubs and methods of manufacture, and may disclose alternative embodiments of golf clubs and methods of manufacture.

All elements claimed in any particular claim are essential to golf clubs or methods of manufacture claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A golf club head comprising:
a body comprising:
a front face;
a back face opposite the front face;
a heel region;
a toe region opposite the heel region and comprising a top toe end portion, and a bottom toe end portion;
a top rail;
a side surface coupled between the top rail and the sole and extended along the top and bottom toe end portions;
a first back face weight located at a perimeter of the back face; and
a second back face weight coupled over the first back face weight and located adjacent to the sole and the toe region;
wherein:
an entirety of the perimeter is substantially covered by the first back face weight;
the side surface further comprises a side surface width extending from the front face towards and beyond the back face;
the side surface width comprises a thickness of the first and second back face weights along the bottom toe end portion;
the side surface width increases non-linearly from the top rail to the sole; and
the side surface width has a maximum side surface width towards the sole.

2. The golf club head of claim 1, wherein:
the first back face weight comprises a first material; and
the second back face weight comprises the first material.

3. The golf club head of claim 1, wherein:
the second back face weight is visibly distinct from the first back face weight from a top view of the golf club head.

4. The golf club head of claim 1, further comprising:
a hosel coupled to a top portion of the heel region such that the hosel is perimetrically opposed to the second back face weight.

5. The golf club head of claim 1, further comprising:
an integral, arcuate reinforcing member at the back face and extending from the heel region to the toe region.

6. The golf club head of claim 1, wherein:
the top rail comprises a substantially constant top rail width; and
the side surface width along the top toe end portion is substantially similar to the top rail width.

7. The golf club head of claim 1, wherein:
the side surface width at the bottom toe end portion is at least three times the side surface width at the top rail.

8. The golf club head of claim 1, wherein:
the second back face weight is integral with the first back face weight.

9. The golf club head of claim 1, wherein:
the first back face weight comprises a first material; and
the second back face weight comprises a second material different from the first material.

10. The golf club head of claim 1, wherein:
the side surface width is substantially constant along a first portion of the side surface;
the first portion of the side surface extends from the top rail to a point adjacent to a midpoint between the top rail and the sole;
the side surface width increases non-linearly along a second portion of the side surface; and
the second portion of the side surface extends from the point to the sole.

11. The golf club head of claim 1, wherein:
at least a portion of the second back face weight is located farther away from the back face than the first back face weight.

12. The golf club head of claim 1, wherein:
the first back face weight separates the back face from the second back face weight.

13. The golf club head of claim 1, wherein:
a perimeter of the second back face weight is elevated relative to a surface of the first back face weight.

14. A golf club head comprising:
a heel region;
a toe region opposite the heel region;
a front face;
a back face opposite the front face;
a top rail extending from the front face towards and beyond the back face;
a sole opposite the top rail and extending from the front face towards and beyond the back face;
a side surface extending from the top rail to the sole at the toe region;
a first back face weight located at an entirety of a perimeter of the back face; and
a second back face weight located over the first back face weight and adjacent to the sole and to the side surface;
wherein:
the side surface comprises a side surface width extending from the front face towards and beyond the back face;
the side surface width is constant along a first portion of the side surface;
the side surface comprises a minimum side surface width at the first portion of the side surface;
the side surface width increases non-linearly along a second portion of the side surface to a maximum side surface width towards the sole;
the top rail extends from the heel region to the toe region, and comprises a top rail width that remains substantially constant from the heel region to the toe region;
the sole comprises a sole width that increases from the heel region to the toe region; and
the sole width is augmented by the second back face weight to a maximum sole width towards the toe region.

15. The golf club head of claim 14, further comprising:
a hosel coupled to a top portion of the heel region such that the hosel is perimetrically opposed to the second back face weight;
wherein:
the second back face weight is visibly distinct from the first back face weight from a top view of the golf club head;
at least a portion of the second back face weight is located farther away from the back face than the first back face weight;
the first back face weight separates the back face from the second back face weight; and
a perimeter of the second back face weight is elevated relative to a surface of the first back face weight.

16. The golf club head of claim 15, further comprising:
an integral, arcuate reinforcing member at the back face and extending from the heel region to the toe region;
wherein:
the first back face weight comprises a first material;
the second back face weight comprises the first material;
the second back face weight is integral with the first back face weight;
the side surface width along the first portion of the side surface is substantially similar to the top rail width;
the maximum side surface width at the second portion of the side surface is at least three times the top rail width;
the first portion of the side surface extends from the top rail to a point adjacent to a midpoint between the top rail and the sole; and
the second portion of the side surface extends from the point to the sole.

17. A method for manufacturing a golf club head, the method comprising:
providing a body comprising:
providing a hosel;
providing a heel region adjacent to the hosel;
providing a toe region opposite the heel region;
providing a front face;
providing a back face opposite the front face;
providing a top rail extending from the front face towards and beyond the back face, and extending from the heel region to the toe region, the top rail comprising a top rail width substantially constant from the heel region to the toe region;
providing a sole opposite the top rail, the sole comprising a sole width extending from the front face towards and beyond the back face;
providing a side surface extending from the top rail to the sole at the toe region;
providing a first back face weight located at a perimeter of the back face; and
providing a second back face weight coupled over the first back face weight and located adjacent to the sole and the side surface;
wherein:
providing the first back face weight comprises:
substantially covering an entirety of the perimeter with the first back face weight;
providing the side surface comprises:
providing a side surface width extending from the front face towards and beyond the back face;
providing the side surface width to be constant along a first portion of the side surface;
providing the side surface to comprise a minimum side surface width towards the top rail;
providing the side surface width to increase along a second portion of the side surface to a maximum side surface width towards the sole;
and
providing the sole comprises:
providing the sole width to increase from the heel region to the toe region; and
providing the sole width to be augmented by the second back face weight to a maximum sole width towards the toe region.

18. The method of claim 17, wherein:
providing the sole further comprises:
providing the sole width to extend to a rear sole edge to create a portion of a rear sole wall; and
providing the rear sole wall to extend from the back face to the back face sole edge.

19. The method of claim 17, wherein:
providing the side surface comprises:
providing a side surface width extending substantially constant along a first portion of the side surface, and increasing non-linearly along a second portion of the side surface;
wherein:
the first portion of the side surface extends from the top rail to a point adjacent to a midpoint between the top rail and the sole; and
the second portion of the side surface extends from the point to the sole.

20. The method of claim 17, wherein:
providing the second back face weight comprises:
providing the second back face weight to be visibly distinct from the first back face weight from a top view of the golf club head.

21. The method of claim 17, wherein:
providing the second back face weight comprises:
providing the second back face weight integrally with the first back face weight.

22. The method of claim 17, wherein:
providing the second back face weight comprises:
providing a material of the second back face weight to be different than a material of the first back face weight.
